(19) United States
(12) Patent Application Publication
(10) Pub. No.: US 2026/0069474 A1
(43) Pub. Date: Mar. 12, 2026

(54) WHEELCHAIR DOCK AND METHOD OF USE

(71) Applicant: The Braun Corporation, Winamac, IN (US)

(72) Inventors: Andrew Henseleit, Noblesville, IN (US); John Hayes, Rochester, IN (US)

(73) Assignee: The Braun Corporation, Winamac, IN (US)

(21) Appl. No.: 19/317,293

(22) Filed: Sep. 3, 2025

Related U.S. Application Data
(60) Provisional application No. 63/692,217, filed on Sep. 9, 2024.

(51) Int. Cl. A61G 3/08

(52) U.S. Cl. CPC A61G 3/0808; A61G 2203/40

(57) ABSTRACT

A wheelchair docking system database may be implemented to communicate with vehicles including docking systems for a wheelchair. The docking system may be coupled to a controller to adjust the height of the docking system. The docking system controller may be in communication an computing device configured to communicate wirelessly with the database and initiate a predetermined set of logic steps. These steps serve to automatically prepare the docking system height for a specific passenger.

### CROSS REFERENCE TO OTHER APPLICATIONS

This application claims priority to U.S. Provisional Ser. No. 63/692,217, filed on Sep. 9, 2024, the contents of which are incorporated by reference. This application also incorporates by reference U.S. Pub. No. US 2021/0069038 A1, published on Mar. 11, 2021, and U.S. Pub. No. US2021/0333796 A1, published October 28,2021.

### FIELD OF THE DISCLOSURE

The present disclosure relates generally to a passenger vehicle (or a fleet of passenger vehicles) that has been modified to safely secure one or more wheelchaired passengers during operation of the vehicle (or fleet of vehicles) in a docking system (or a plurality of docking systems), and more particularly to storing wheelchair data and executing logic to automatically adjust the height of the docking system(s) for each passenger.

### BACKGROUND

This section introduces aspects that may help facilitate a better understanding of the disclosure. Accordingly, these statements are to be read in this light and are not to be understood as admissions about what is or is not prior art.

Automobile manufacturers do not currently mass-produce passenger motor vehicles specifically designed to transport passengers having physical limitations. Consequently, mass-produced passenger vehicles are modified, or retrofitted, by a number of aftermarket companies dedicated to supplying vehicles for physically limited passengers. Such vehicles can be modified by altering or adding certain parts or structures within a vehicle to accommodate the physically limited passenger. The equipment that may be fitted to an accessible vehicle includes, but is not limited to, devices configured to allow a wheelchaired passenger access to entering the vehicle such as a ramp or lift, and wheelchair restraint system for safely securing the wheelchaired passenger during vehicle operation.

One known method for restraining a wheelchair is a wheelchair docking system. Historically, docking systems were typically only used in private vehicles because they were provided with a fixed, user-specific configuration that was usually only compatible with a single wheelchair. More, recently however, wheelchair docking systems that are height adjustable and can be easily configured to the mobility passenger's wheelchair configuration have been proposed, e.g., for use in commercial vehicles where they may need to accommodate various wheelchairs for different wheelchaired passengers (or in a private vehicle for a single passenger who may possess multiple wheelchairs). However, adjusting the height of commercially available docking systems is a manual process that requires the operator of the vehicle to readjust the dock to an appropriate height each time a new or different wheelchair is being secured, which requires a certain amount of technical know-how and dexterity, increases dwell times at pick-up locations, and creates a risk of operator injury. Moreover, the advent of autonomous rideshare vehicles introduces additional problems, including the absence of a human operator. Therefore, there is a need for an automatically height adjusting docking system, that can recognize wheelchair configurations and adjust the height of the wheelchair docking system accordingly.

### SUMMARY OF THE EMBODIMENTS

The problems of the prior art docking systems may be solved by incorporating a database that stores passenger-specific data (e.g., configuration and characteristics of the wheelchair, such as the location or height of the wheelchair's coupling device) regarding the passenger's wheelchair. Each time the passenger uses the docking system, the docking system may reference and use the stored data to aid with space preparation and user comfort. A fleet of docking systems and vehicles may be networked together, whereby the passenger will be able to seamlessly move from vehicle to vehicle in rideshare, public, or private settings without having to move the dock to the correct settings for their particular wheelchair.

Users of a networked docking system may have dock metadata and/or other information regarding the characteristics and configuration of the wheelchair stored into a common database. The information stored in the database can then be made be available for use in other networked docks that are installed in rideshare, public, private, and all other forms of vehicle use to ensure the docking systems are at the correct settings for proper dock alignment and engagement based on personal settings. Information regarding the characteristics and configuration of the wheelchair can be gathered in a number of ways, both by manual/human entry and automatically, through the us of dealership tools, wirelessly via over-the-air (OTA), phone applications, physical hardware, a web portal, and other means.

In one implementation of the system, a user can set a networked dock to the correct settings (e.g., height). The height of the dock (which corresponds to the height of the wheelchair's coupling device) can be uploaded to a user's profile in the database via one of the many communication mediums used in the world today. The height could be in traditional metric or imperial units, or it could be a value relative to full travel of the dock. When the user moves into another vehicle with a networked dock, the dock may pull the information stored in the database for that user from the database through the communication medium and automatically adjust the settings of the networked dock to the stored height. If a user changes the height in any application, it can be changed in the database and propagated through all units they use from that point forward. If the user owns more than one chair, information concerning both chairs may be stored in the database and associated with the user's profile to provide a seamless experience for the passenger.

In an alternate implementation, the docking system could send the height or other unique value used to secure the wheelchair to the user, driver, or technician (e.g., via a user interface, digital display, etc.) to be used for future docking experiences. The value could then either be transmitted to or entered manually through a phone or other interface to the dock.

In yet another alternate implementation, the height of the wheelchair docking system could be measured just prior to docking. This could be done by measuring the distance from a module mounted to the wheelchair, or it could be measured from a component on the wheelchair dock or on the floor of the vehicle, measuring up to the wheelchair as it approaches. The measuring type could be lidar, vision, sonar, ultrasonic, electromagnetic, etc. Alternately, there could be a sequence done to measure the distance using a method that raises the dock up to the point it contacts the wheelchair, sensing from a contact or non-contact sensor or by resistance sensed through the electronics/motor/actuator that drives the dock in the vertical motion. This could be done by monitoring current, speed or any combination of the two or other manners able to be sensed through the drive mechanism.

The user's profile stored in the database may include additional information concerning the passenger, such as the passenger's name or ID number, wheelchair name or ID number, medical conditions, wheelchair model, wheelchair configuration, passenger weight, wheelchair weight, etc. With a populated database, there exists an opportunity to gather and extract data on all different types of wheelchairs. For example, it could determine the average wheelchair coupling device height for a given wheelchair make and model. In the event that a new user enters the vehicle with an unknown coupling height, the docking system may reference and use the average height setting for the user's wheelchair make and model.

In one embodiment of the present disclosure, a passenger vehicle has been modified to accommodate wheelchaired passengers. The vehicle may include a wheelchair access device such as a ramp or a lift to facilitate entrance to the vehicle. Interior of the vehicle, there is a wheelchair docking device coupled to the floor. The docking device includes a coupler mechanism to couple to the wheelchair coupling device, and an actuator to adjust the height of the coupler mechanism relative to the vehicle floor. The wheelchair includes a bottom surface supported by the wheels and a coupling device positioned on the bottom surface. A clearance is defined between the coupling device and the floor and may be adjustable.

In another embodiment of the present disclosure, the vehicle or docking system has a method of recognizing the wheelchair configuration entering the vehicle. There may be a scanner at the entry point of the vehicle, or on the wheelchair access device, that scans a unique identifier on the wheelchair. The unique identifier may be a microchip, RFID, barcode, wheelchair or passenger name, or any other known method of unique identification. The scanning device may also use a vision system to gather the wheelchair model or wheelchair coupling device clearance height. Other commonly known methods for detecting unique objects may be used in conjunction with or in substitution of the aforementioned methods of detection.

In another embodiment, the docking system has a sensor, such as a line-of-sight, lidar, vision, sonar, ultrasonic, electromagnetic, encoder, or any other known sensor for determining the position of an object to capture the height of the docking system. The sensor may measure the height of the wheelchair receiving portion of the docking device, or it may be configured to measure any moving component on the wheelchair dock through the travel from the minimum height to the maximum height.

In another embodiment, the wheelchair configuration data is captured and stored in a database. The database may be an app, a dealership tool, an over-the-air wireless server, or any other known method for remotely storing data. The data collected may be the wheelchair model, the specific wheelchaired passenger, or any other distinguishing factor for wheelchairs, along with the wheelchair coupling device clearance height or any other useful metrics.

In another embodiment, an computing device is used to execute logic for adjusting the height of the docking system. The computing device receives inputs from the wheelchair scanning device. The computing device may then reference the database against the input. If the wheelchaired passenger or that wheelchair configuration has been used on a docking system previously, the computing device may send a command to the docking system controller. The docking system controller may be operatively connected to the actuator and the height sensor to adjust the height of the docking device to the necessary height.

In another embodiment, a new wheelchaired passenger may have a wheelchair configuration not stored in the database. A sequence for adjusting the height of the docking system manually may be provided to the passenger. The detection of a new wheelchaired passenger may initiate the computing system to send a signal to the dock controller to trigger the dock control screen to walk the passenger through a set-up mode to configure the dock height for the new wheelchair. Upon completion of adjusting the height, the new wheelchair configuration may be sent to the database.

In another embodiment, when a new wheelchaired passenger enters a vehicle, there may be an automated method for determining the height required by the docking system. The docking system may have one or more sensors to detect the clearance height of the wheelchair dock engaging device. The sensor may also be in the vehicle adjacent to the accessible entry or on the wheelchair ramp or lift. This determining step may occur anytime between the wheelchaired passenger entering the vehicle and positioning their wheelchair in the docking area, contingent on where the sensor is positioned in the vehicle. Once the docking device is deployed and secured for the first time to a new wheelchair, the height of the docking device may then be sent to the database for future use.

In some embodiments, the method further comprises operatively connecting the computing system to a network to facilitate communication with the database.

In some embodiments, the database may communicate with one or more of rideshare service fleet of vehicles or personal vehicles. The database may also be configured to communicate with a vehicle having one or more docking systems. This ensures that the same wheelchaired passenger does not have to enter the same vehicle or dock each time to ensure automatic securement.

In some embodiments, the method comprises securing the wheelchair to the docking system. The securement process includes engaging the coupler mechanism of the docking system with the coupling device of the wheelchair. The wheelchair dock may then reduce the height relative to the vehicle floor of the coupler mechanism.

In some embodiments, docking systems may be utilized in autonomous vehicles. The computing system may be configured to receive signals from the dock controller regarding the status of the docking system, such as coupled with the wheelchair coupling device. Further, the computing system may be in communication with the vehicle systems to disengage the dock when the passenger arrives at the desired destination. The computing system may also be operatively connected to the vehicle to prevent operation until the wheelchaired passenger is secured.

In some embodiments, certain values stored in the database may be provided to rideshare services to assist with route planning, or any other helpful use.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a prior art wheelchair docking system and a wheelchair.

FIG. 2 illustrates the vehicle systems working together to automatically adjust the docking system height.

FIG. 3 illustrates a flowchart of logic for collecting and using the database.

FIG. 4 illustrates a flowchart of steps for manually adjusting the dock for a new passenger.

FIG. 5 illustrates a flowchart of steps for automatically adjusting the dock for a new passenger.

Corresponding reference numerals are used to indicate corresponding parts throughout the several views.

It should be understood that the drawings are not necessarily to scale and that the embodiments are sometimes illustrated by graphic symbols, phantom lines, diagrammatic representations, and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

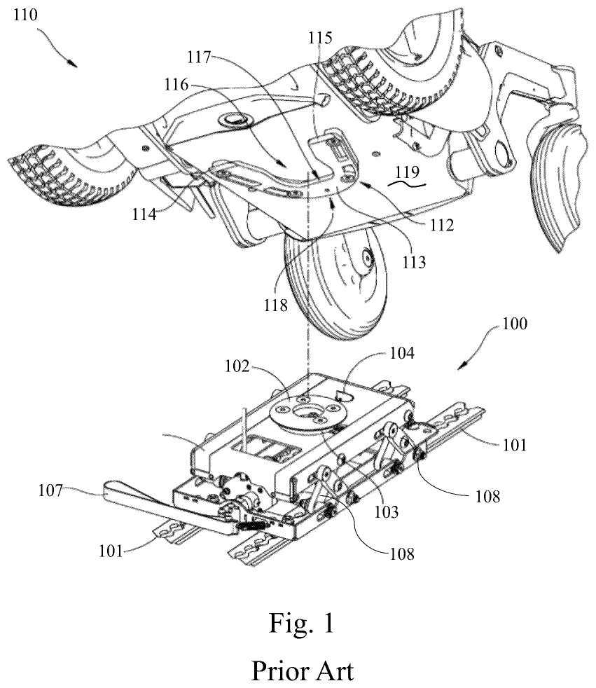

FIG. 1 illustrates a perspective view of a prior art docking system 100 and a wheelchair 110 configured to engage with the docking system 100. The docking system 100 may be mounted to at least one or more tracks 101, or to the vehicle floor directly. The docking system 100 has a receiving device 102, configured to engage or lock with the coupling device 112 mounted on an underside surface 119 on wheelchair 110. The wheelchair 110 may be a manual wheelchair, powered wheelchair, scooter, or any other personal mobility device for a physically limited passenger.

In the embodiment of FIG. 1, the receiving device 102 has a disc portion 103, while the coupling device 112 has a bracket 113 with a first coupling portion 114 and a second coupling portion 115 defining an opening 116, an opening surface 117 to contact the disc portion 103, and a back surface 118 for engagement with the locking pin 104 on the docking system 100. The locking pin 104 prevents the bracket 112 from shifting away from the disc portion 102 and disengaging during vehicle operation. Other configurations of and alternatives for the receiving device 102, coupling device 112, and locking pin 104 are contemplated.

The docking system 100 may also include motors/linear actuators (not shown), a plurality of linkages 108, and/or other structures configured to raise or lower the receiving device 102 to match the height of the coupling device 112. Alternatively, the coupling device may be configured with motors/linear actuators, linkages, and/or other structures (not shown) configured to raise or lower the coupling device 112 to match the height of the receiving device 102. The docking system may also have one or more cables 107 or other manual or emergency releases to allow height adjustment in the absence of power. Additionally, one or more sensors may be provided, e.g., on the wheelchair 119 or coupling device 112, to determine the height of the coupling device 112 relative to ground, where the sensor(s) is(are) configured to communicate the measured height to the docking system 100.

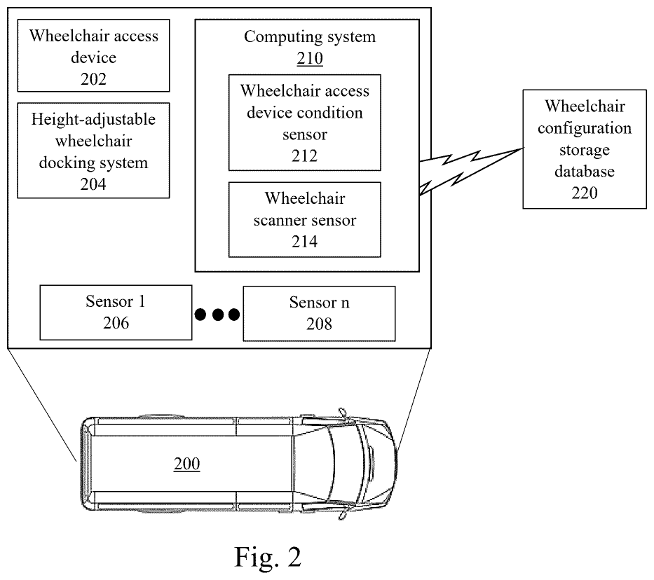

FIG. 2 illustrates a system for automatically adjusting the height of a wheelchair docking system (e.g., the receiving device and/or the coupling device, whichever is height adjustable) in a vehicle 200. In addition to a height-adjustable wheelchair docking system 204, which may be similar to prior art docking system 100, vehicle 200 may also include a wheelchair access device 202, e.g., in the form of a wheelchair ramp, a lift, or any other known method of allowing a wheelchaired passenger to travel from one surface to another at a different elevation. The system includes a computing system 210 configured to execute logic for adjusting the height of the wheelchair docking system 204. The computing system 210 may be configured to receive inputs from one or more sensors, such as a wheelchair access device condition sensor 212 and a wheelchair perception sensor 214, as described more fully below. The wheelchair perception sensor 214 may comprise one or more sensors 206, 208, including but not limited to a RFID tag reader, QR Code reader, a camera sensor, a LiDAR sensor, a ToF sensor, a RADAR sensor, a EmDAR sensor, a SONAR sensor, a SODAR sensor, a GNSS sensor, an accelerometer sensor, a gyroscope sensor, an IMU sensor, an infrared sensor, a laser rangefinder sensor, an ultrasonic sensor, an infrasonic sensor, a microphone, similar devices, and other devices known in the art capable of perceiving a wheelchair, its configuration, and/or its characteristics (e.g., identity, height of coupling device 112, weight, model, etc.). The sensor(s) may be disposed in or on the vehicle 200, the wheelchair access device 202, the docking system 204, or the wheelchair 119, or any combination thereof.

In one example system, a single vehicle 200 is provided with an internal computing system and an internal database 220. In another example system, multiple vehicles 200 are provided, each having their own internal computing system 210, and those vehicles'computing systems 210 are configured to communicate with a single, remotely located database 220. Each such computing system may comprise memory that syncs periodically or on command with the remotely located database 220 to keep a local copy of the data stored in the database 200. In one variation of that system, computing system 210 may comprise multiple computing systems, e.g., all internal to the vehicle, all remotely located, or one or more internal to the vehicle 200 and one or more remotely located, that cooperate to perform the functions described herein. In yet another example system, a single computing system 210 and database 220 may be configured to service multiple vehicles 200. In yet another example system, multiple vehicles 200 are provided, each having their own computing system 210 and database 220, whereby the databases 220 may be configured to sync periodically or on command. In additional example systems, the computing system 210 and database 220 may be disposed on the docking system 204.

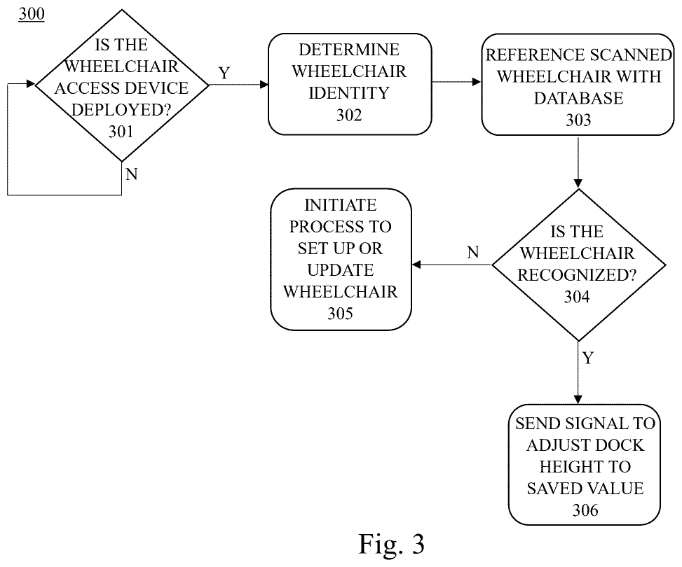

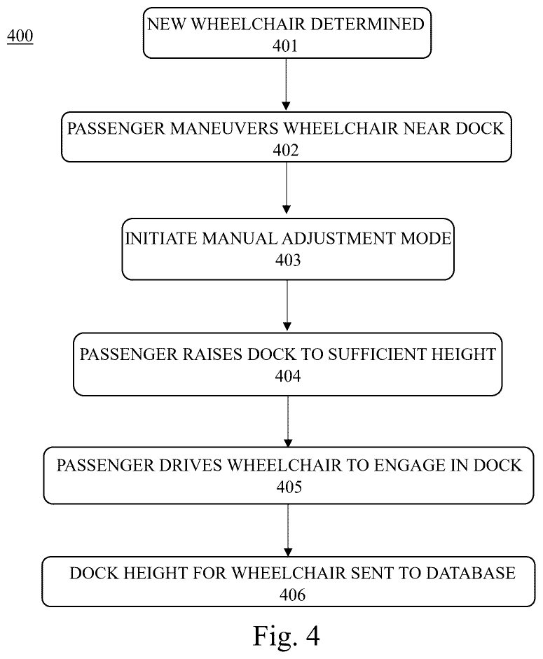

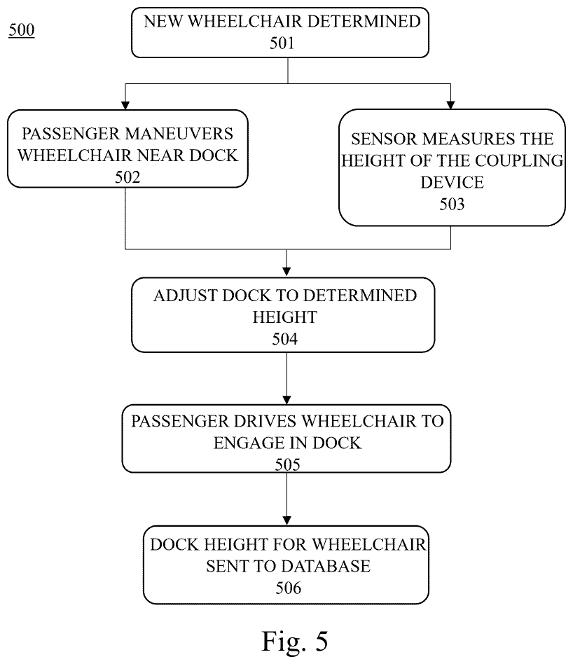

FIG. 3 is a flowchart that illustrates steps (logic 300) that may be performed by the computing system 210 to adjust the height (or other characteristic) of the docking system 204. In the first step of logic 300, the computing system 210 may reference input from the wheelchair access device condition sensor 212 (if present) to determine if the wheelchair access device 202 is in a deployed condition, whereby the wheelchair 119 can board the vehicle 200. If yes, in a second step 302, the computing system 210 may reference input from the wheelchair perception sensor 214 to determine the identity of the wheelchair entering the vehicle 200. In step 303, the computing system 210 then references information stored in the database 220 for identified wheelchair, if any, which may include any configuration or characteristic of the wheelchair, such as the height of the coupling device. In step 304, the computing system 210 determines if the wheelchair configuration or characteristic is stored in the database 220 or not, effectively deciding if the passenger has used or been appropriately set up to use a docking system within the vehicle (or network of vehicles). If the computing system 210 receives sufficient information concerning the wheelchair from the database 220, the computing system 210 will send a signal to the docking system 204 to adjust the height to the stored value in step 306. If the computing system 210 does not receive sufficient information from the database 220, the computing system 210 initiates a process to collect the necessary information and store that information in the database 220 in step 305. Such information can be input manually as presented in logic 400 in FIG. 4 or automatically in logic 500 in FIG. 5.

It is contemplated that the computing system 210 may be programmed to repopulate the data stored in database 220 for a given wheelchair, even if data for that wheelchair is already present in database 220. For instance, to avoid data becoming stale due to changing conditions (aging wheelchair suspension, change in weight of passenger), the computing system 210 may be programmed to initiate a process to update the information in database 220 after a predetermined period of time. As another example, the computing system 210 may be programmed to repopulate the data stored in database 220 if the wheelchair perception sensor 214 detects a change in a wheelchair configuration or characteristic.

FIG. 4 is a flowchart that illustrates steps (logic 400) that may be performed by the computing system 210 in cooperate with a human operator to create data for a new wheelchair or update data for an existing wheelchair in the database 220. In step 401, which corresponds to step 305 of FIG. 3, the computing system 210 has determined that data (e.g., height data) needs to be collected for a new wheelchair, or such data needs to be updated for an existing wheelchair. This triggers the computing system 210 to permit manual height adjustments from a dock input device (e.g., a control switch, panel, or screen in the vehicle or a personal computing device) in step 403. Concurrently, the passenger may maneuver their wheelchair in the vehicle or adjacent to the docking system 204 in step 402. The input device may comprise a screen that displays instructions for the passenger to manually adjust the docking system 204 height in step 404. Once the docking system 204 height is set for the passenger, they will maneuver their wheelchair to engage into the docking system 204 in step 405. In step 406, the dock height cross referenced with an identification for the associated wheelchair, along with any other useful data that may be collected, may then be sent to the database 220 for storage and future reference.

FIG. 5 is a flowchart that illustrates steps (logic 500) that may be performed by the computing system 210 to automatically create data for a new wheelchair or update data for an existing wheelchair in the database 220, without the need for human involvement. In step 501, which corresponds to step 305 of FIG. 3, the computing system 210 has determined that data (e.g., height data) needs to be collected for a new wheelchair, or such data needs to be updated for an existing wheelchair. In step 502, the passenger will maneuver their wheelchair into the vehicle or near the docking device 204. In step 503, the computing system 210 receives input indicative of the height of the coupling device 112 from the wheelchair perception sensor 214, which as described above may comprise one or more sensors 206, 208. In one example embodiment, the wheelchair perception sensor 214 may be sensor disposed on the wheelchair that determines the ground clearance of the coupling device 112. In another example, the wheelchair perception sensor 214 may be a camera disposed in the vehicle or on the docking system 204. Images from such a camera can be processed using video analytics software to determine the height of the coupling device 112. Upon receipt of input indicative of the height from the perception sensor 214, in step 504, the computing system 210 may then send the signal to the docking system 204 to adjust to the required height. Further, in step 506, the computing system 210 may send the dock height cross referenced with an identification for the associated wheelchair, along with any other useful data that may be collected, to the database 220 for storage and future reference. With the docking system 204 moved to the correct height, in step 505, the passenger may then maneuver their wheelchair to engage in the docking system 204.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims. For avoidance of doubt, the computing system 210 may omit some of the steps and/or include additional steps not shown or described herein. The computing system 210 may also perform these steps sequentially, or in any order as appropriate. Additionally, the computing system 210 may automatically progress from one step to another or may request confirmation or approval from a vehicle operator or passenger, e.g., through an input device in the vehicle or a personal computing device, e.g., iPhone, iPad, or similar device, before proceeding from any one step to the next step.

1. A wheelchair securement system comprising:
a docking system configured for mounting to an interior of a vehicle, wherein the docking system includes a coupler mechanism, an actuator configured to adjust a height of the coupler mechanism relative to a floor of the vehicle, and a sensor outputting a signal indicative of the height of the coupler mechanism;
a perception sensor configured to detect an identity of a wheelchair;
a computing device configured to receive the identity of the wheelchair from the perception sensor, interrogate a storage device based on the identity, receive a height setting from the storage device, and adjust the height of the coupler mechanism based on the height setting.

2. The wheelchair securement system of claim 1, wherein the wheelchair can be any of an electric wheelchair, manual wheelchair, scooter, or any other personal mobility device;
wherein, the wheelchair further comprises a set of wheels configured to rest on the floor of the vehicle, a bottom surface supported above the floor by the set of wheels, and a coupling device positioned on the bottom surface;
wherein a clearance distance is defined between the coupling device and the floor.

3. The wheelchair securement system of claim 2, wherein the coupling device of the wheelchair is configured to engage the coupler mechanism of the docking system when the wheelchair is secured to the docking system.

4. The wheelchair system of claim 3, wherein the wheelchair further comprises a unique identifier which may be at least one of: the name of the wheelchair, the name of the passenger, a barcode, a microchip, or an RFID tag associated with that wheelchair.

5. The wheelchair system of claim 4, wherein the perception sensor is positioned in a path a passenger would maneuver the wheelchair from atop an access device through an entryway of the vehicle and inside the vehicle to the wheelchair securement system and scans the unique identifier when the wheelchair enters.

6. The wheelchair system of claim 4, wherein the perception sensor is positioned adjacent to or integrated within the docking system.

7. The wheelchair system of claim 4, wherein the perception sensor is configured to measure the clearance distance.

8. The wheelchair securement system of claim 1, wherein the storage device is located on the wheelchair docking station.

9. The wheelchair securement system of claim 1, wherein the storage device is located in a location outside the vehicle remotely accessed by the computing device via wireless communication.

10. The docking system of claim 1, wherein the if the perception sensor does not detect the identity of the wheelchair, the computing device is configured to unlock the docking system for manual operation.

11. The docking system of claim 10, wherein the computing system provides instructions for manually setting the height of the docking station.

12. The docking system of claim 11, wherein the computing system is configured to send a signal to add the height of a new passenger to the storage device.

13. The docking system of claim 2, wherein the computing system is configured to update the height setting in the storage device if the perception sensor detects a change of the clearance.

14. A method of operation for a wheelchair securement system comprising a height-adjustable dock:
receiving an identity of a wheelchair from a perception sensor;
interrogating a storage device to obtain a height setting based on the identity;
adjusting a height of the height-adjustable dock based on the height setting.

15. The method of claim 14, further comprising:
securing the wheelchair to the docking system;
wherein securing the wheelchair to the docking system includes:
engaging a coupler mechanism of the docking system with the coupling device of the wheelchair; and
reducing the height of the docking system after the coupler mechanism of the docking system is engaged with the coupling device of the wheelchair, to reduce the clearance distance defined between the coupling device and the floor.

16. The method of claim 15, wherein the perception sensor detects a new user, comprising:
measuring a clearance of the coupling device of the wheelchair to a floor of the vehicle;
setting the height-adjustable dock to a determined height;
securing the wheelchair to the dock; and,
sending a height value to the storage device corresponding to the identity of the new user.

17. The method of claim 15, wherein the perception sensor detects a new user, comprising:
unlocking the height-adjustable dock to be manually adjusted; and,
sending a height value to the storage device corresponding to the identity of the new user.

18. The method of claim 17, further comprising providing instructions for a process to manually set the height setting of a height-adjustable dock.

19. A wheelchair securement system comprising:
a dock having a height adjustable coupler mechanism configured to lockingly engage with a coupling device on a wheelchair;
a dock controller configured to:
receive a first input indicative of an identity;
interrogate a storage device to obtain a second input indicative of a height of the coupling device based on the first input;
adjust a height of the coupler mechanism based on the second input.

20. The wheelchair securement system of claim 19, wherein the first input is indicative of the identity of at least one of the wheelchair and a passenger of the wheelchair.
